(19) United States
(12) Patent Application Publication
(10) Pub. No.: US 2002/0069004 A1
(43) Pub. Date: Jun. 6, 2002

(54) Method for determining a seating position of an object on a vehicle seat

(76) Inventors: Reiner Marchthaler, Gingen (DE); Thomas Lich, Schwaikheim (DE); Frank Mack, Stuttgart (DE)

Correspondence Address: KENYON & KENYON, ONE BROADWAY, NEW YORK, NY, 10004, US

(21) Appl. No.: 09/962,943

(22) Filed: Sep. 24, 2001

(30) Foreign Application Priority Data
Sep. 23, 2000 (DE) 1 00 47 191.9-34

(51) Int. Cl. G06F 7/00

(52) U.S. Cl. 701/49

(57) ABSTRACT

A method for determining a seating position of an object on a vehicle seat that is used for establishing the seating position of the object on the vehicle seat. The seating position is established by one or more centers of gravity. The seating position is then used in conjunction with additional features, for example the distance between the ischial tuberosities or the seating profile size or a weight estimate for occupant classification. The seating position is also used for evaluation of the seating profile. Additionally, the seating position may be used for other vehicle systems such as a rollover detection system and also for checking the plausibility of other sensor values.

### BACKGROUND INFORMATION

K. Billen, L. Federspiel, P. Schockmehl, B. Serban and W. Scherrel, in: Occupant Classification System for Smart Restrained Systems, SAE Paper, 1999, page 33 to page 38, describe a seat mat having a sensor matrix, the sensor matrix being used for the continuous generation of a seating profile of different persons and things. Features that are used for occupant classification are established in the seating profile.

### SUMMARY OF THE INVENTION

The method according to the present invention for determining a seating position of an object on a vehicle seat has the comparative advantage that the determination of seating position permits better occupant classification, because seating position leads to a higher correlation of occupant weight and the feature or features that are derived from the seating profile. Weight and hence occupant classification are determined via the features.

In addition, determination of the seating position advantageously makes it possible to produce a better time filter for the seating profile, since the seating position permits more reliable conclusions to be drawn concerning seating profile quality. Overall, therefore, determination of the seating position results in better occupant classification and hence, in the case of restraint systems, better operation of restraint systems such as airbags or seat belt tensioners.

It is especially advantageous for the seating profile to be divided up into regions and then for a center of gravity to be calculated for each region. Better establishment of the seating profile is thus made possible, particularly in order to establish different seating positions.

In addition, it is advantageous for allocation to different seating positions to be obtained by a comparison of determined centers of gravity with stored data. This allows a manufacturer to establish, in a simple fashion, which seating positions are determinable by the method according to the present invention.

Furthermore, it is advantageous that the occupant classification is improved by linking the seating position with at least one additional feature, for example with seating profile size or distance between the ischial tuberosities. This permits more accurate occupancy classification and hence improved operation of the restraint system.

It is additionally advantageous for evaluation of the seating profile itself to be made with the seating position. Poor seating profiles can thus be better identified, so that they will not be used for establishment of a feature and thus for occupant classification. In such a case, an occupant classification already present continues to be used. The seating profile is continuously determined, so that new data are continuously available.

In addition, it is advantageous for the seating position to be made available to additional systems, such as a rollover detection system, in order to further improve the sensing of these other systems. At the same time, it is also advantageous for the seating position to be used as a plausibility check for other sensor values, in order to avoid erroneous sensor signals and hence incorrect responses of vehicle systems.

Lastly, it is also advantageous that a device that has a sensor matrix, a processor and a memory be present in order to carry out the method according to the present invention.

### BRIEF DESCRIPTION OF THE DRAWINGS

FIG. 1 shows the device according to the present invention as a block diagram.

FIG. 2 shows the method according to the present invention for determining a seating position of an object on the vehicle seat as a flow diagram.

FIG. 3 shows a possible division of the seat into different fields.

### DETAILED DESCRIPTION

Depending upon the situation, a person or a thing as an object that is seated on a vehicle seat has a different seating position on the vehicle seat. Such situations are dependent upon vehicle parameters such as vehicle speed, turning motion of the vehicle (rounding curves), vehicle acceleration, and a person's sitting habits. However, the seating position is of great importance for restraint systems, rollover detection and additional vehicle systems, in order to optimally adjust responses of these vehicle systems to the object, person or thing found on the vehicle seat. In addition, the determined seating position is advantageous for checking the plausibility of other sensor values, since erroneous sensor values, which would result in wrong responses of vehicle systems, can thus be disregarded.

According to the present invention, therefore, a method for determining a seating position of an object on the vehicle seat is implemented, the seating position being established via at least one center of gravity. Division of a seating profile into regions makes it possible to indicate an additional center of gravity per region and hence enable a more accurate analysis of seating position to be made than is possible with only one center of gravity. Comparison of determined centers of gravity with stored data permits accurate allocation to different seating positions. Linkage of the seating position with an additional feature, such as seating profile size or distance between the ischial tuberosities or a weight estimate, makes occupant classification possible. Evaluation of the seating profile with the use of a seating position is also possible in simple fashion.

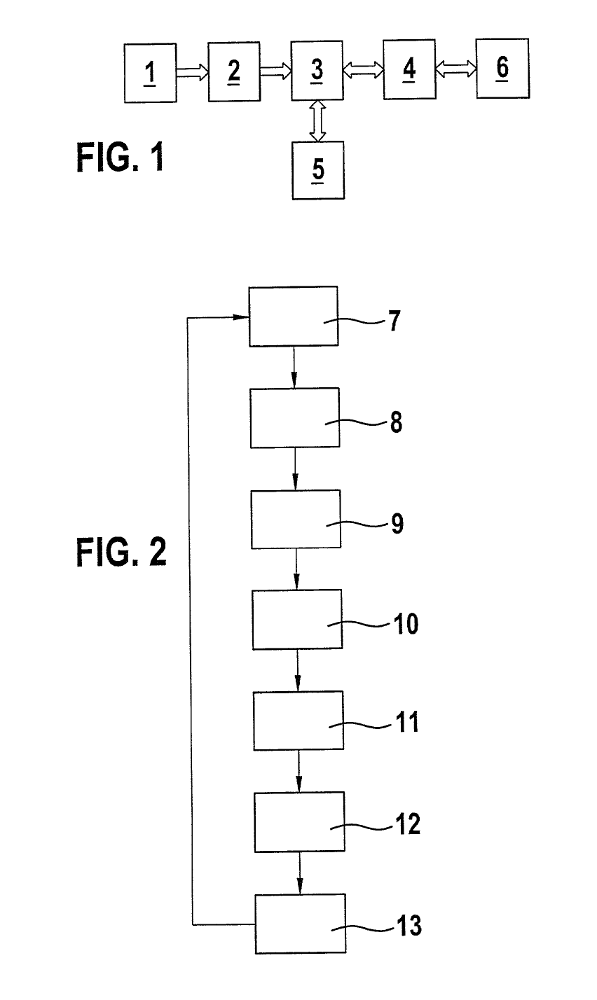

The device according to the present invention for carrying out the method of determining a seating position of an object on a vehicle seat is represented in FIG. 1 as a block diagram. A sensor matrix 1 is connected to an analog-digital converter 2 via an output. A data output of analog-digital converter 2 leads to a processor 3. Processor 3 is connected by a first data input/output with a memory 5 and via a second data input/output with a control device 4. Control device 4 is connected by its second data input/output with a restraint system 6. Analog-digital converter 2, processor 3 and memory 5 are accommodated in a housing in a conventional fashion as a control unit. Here processor 3 is a microcontroller. However, other types of processors are alternatively possible.

Pressure sensors are arranged in a matrix in sensor matrix 1. The pressure sensors exhibit decreasing resistance upon increasing pressure. The sensor matrix is measured columnwise and linewise with regard to resistance, whereupon determination of the resistances of the individual pressure sensors and the compressive load thus is then possible. This measurement is effected so as to measure currents. Voltage potentials are initially applied to the individual pressure sensors on the columns and tows so that no currents flow. When the voltage potential is varied by processor 3, currents can flow through a particular pressure sensor. The line for control by processor 3 from processor 3 to sensor matrix 1 is not shown here. Thus the resistance value for the respective pressure sensor is determinable by processor 3. The individual pressure sensors are sequentially queried by the variation of voltage potential on the rows and columns, so that the current values reach analog-digital converter 2 one after another over a line. These current values are digitized by analog-digital converter 2. The digital current values are then transmitted to processor 3, which first uses them to calculate the resistance values and generates the seating profile of sensor matrix 1. With the resistance values, it is now possible to establish the center of gravity of the seating profile, because the center of gravity is found where the lowest resistance values are measured, i.e., where the greatest pressure has been exerted on the sensor matrix. The center of gravity is determined by processor 3 by a calculation according to the known formula for the center of gravity. Then a position that indicates the center of gravity is present.

If the seating position is to be still better identified, processor 3 carries out a division of the seating profile into different regions. Then processor 3 calculates a particular center of gravity for each of these regions. These regions may for example be different quadrants. Different seating positions are specified, and the centers of gravity are compared with stored thresholds, so that identification of the seating position is made as a function of the comparison. Thus, the comparison is a comparison of positions. If the calculated center of gravity lies above a particular threshold, the seating position that belongs to this threshold is identified. The seating profile is likewise divided into regions for these seating positions, and seating positions are then assigned to the centers of gravity in the individual regions. Seating positions in which for example the thighs are pressed onto the vehicle seat are also taken into account here.

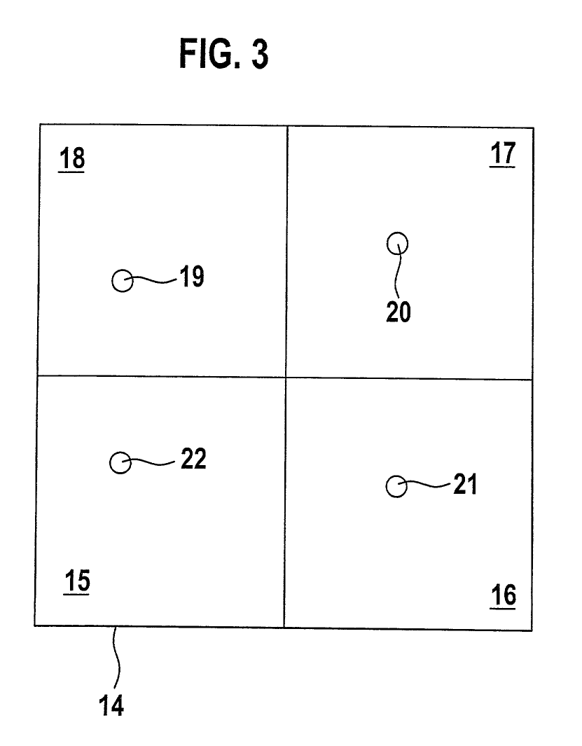

A possible division of the seat into different fields is shown in FIG. 3. First, however, the absolute center of gravity is calculated, on the basis of which the fields are divided. A seat 14 has quadrants 15, 16, 17 and 18. The origin of quadrants 15-18 is established by the absolute center of gravity that the processor has previously determined on the basis of resistance values. Centers of gravity 19, 20, 21 and 22, calculated by processor 3, are shown in individual quadrants 15-18. Centers of gravity 19 to 22 now make it possible for processor 3 to determine a seating position by making a comparison with stored values in memory 5. In particular, it is possible here to determine a seating position with a pressed-on thigh or a twisted seating position. Therefore frequently encountered seating positions are easily determinable. Here this comparison is effected in detail by summation of the distances between centers of gravity. In this connection, for the sake of simplicity only the horizontal component of the distance vector between centers of gravity 19 and 20 as well as the distance vector between centers of gravity 21 and 22 is evaluated here. Optionally, the vertical component of the distance vector between centers of gravity 19 and 21, as well as 20 and 22 is also or alternatively used. These components are then added up and lastly compared with a set of threshold values in order to establish a seating position. There the intervals between the threshold values into which the sum ultimately falls then determine the seating position. That is to say, specific seating positions are allocated to the intervals. Appropriate tests have been performed for this purpose.

After determination of the seating position, processor 3 also carries out a feature determination (distance between the ischial tuberosities, weight and seating profile size (i.e., human area)) using the seating profile. It is alternatively possible for feature determination to be made directly, using the calculated resistance values.

Overall consideration of the determined seating position and the features that processor 3 has determined from the seating profile makes occupant classification possible. Here division into five classes is made for occupant classification. Such a division into classes is important primarily for multiple-stage airbags since, in multiple-stage airbags, the deployment force of the airbag is selected by the restraint system as a function of the class. Each stage of the airbag thus corresponds to a given force with which the object is acted on by the airbag in a crash. Class division for the occupants takes place chiefly by weight and, in refinements, also as a function of other features such as the seating position.

Processor 3 then transmits the occupant classification to control device 4, which uses it to adjust restraint system 6 optimally for possible use. In addition, it is possible for processor 3 to be connected via a vehicle bus, for example via a CAN (controller area network) bus, with other vehicle components in order to transmit the seating position to these additional vehicle components. This seating position can be advantageous for a rollover detection system or for an out-of-position sensor. An out-of-position sensor detects whether an object is located too close to the airbag, in which case the risk of injury is great.

Processor 3 uses for example the distance between the ischial tuberosities or the size of the seating profile as additional features. An added feature is a weight estimate, which is likewise determinable by means of sensor matrix 1.

Since the seating profile is a function of time and has a variable quality at different points in time, the seating position may also be used for determining seating profile quality. This may be done either by making a case-by-case distinction via the different seating positions or via a value that is allocated to the seating position and then is entered into the equation for seating profile quality or alternatively for the calculation of features.

In this way, assessment of profile quality is distinctly improved, because in certain seating positions, e.g., when the occupant sits shifted far outward, the information content of the seating profile, because of the small number of sensors in the outer field, is evidently lower than when the occupant sits in the reference position, i.e., in the center of the seat. It is possible to obtain improvement in a time filter for seating profiles in this way. The seating position may also be used for classification, in that mapping of the feature area that is encompassed by the various features such as distance between the ischial tuberosities or seating profile size, is carried out on the weight class of the occupant as a function of the seating position.

The method for determining a seating position of an object on a vehicle seat is represented in FIG. 2 as a flow diagram. In method step 7 sensor matrix 1 sequentially supplies the currents that flow through the individual pressure sensors, from which processor 3 then determines the seating profile and the resistance values for the individual pressure sensors. For this purpose, analog-digital converter 2 carries out digitization of the current values of the pressure sensors. Processor 3 calculates resistance values for the individual pressure sensors from the digitized current values.

In method step 8 processor 3 determines the seating profile in order to determine, in step 9, the center of gravity from it. If processor 3 divides the seating profile into different regions in method step 8, calculation of the centers of gravity for each individual region, for example for the separate quadrants, takes place in step 9. In method step 10, processor 3 allocates a seating position to the center or centers of gravity, in that processor 3 goes back to stored thresholds in memory 5. Seating positions are allocated to the thresholds as set forth above. This is effected by for example forming the difference between the measured centers of gravity and the stored thresholds, which in each instance characterize a seating profile. If the differences lie above a predetermined threshold, the respective seating profile that is allocated to this threshold is recognized.

In method step 11 processor 3, using the seating position, carries out a feature determination and a calculation of seating profile quality. In feature determination, particularly the distance between the ischial tuberosities, the seating profile size and a weight estimate are used. In method step 12 processor 3 carries out occupant classification using the calculated features and the seating position. In step 13 processor 3 transmits the seating position and the occupant classification to for example control device 4 for restraint systems 6. However, it is alternatively possible to allocate occupant classification to other vehicle systems. Seating position and occupant classification are of use especially for rollover detection systems and for checking the plausibility of other interior sensor values.

What is claimed is:

1. A method for determining a seating position of an object on a vehicle seat, the vehicle seat including a seat mat with a sensor matrix, the method comprising:
determining a seating profile of the object using the sensor matrix;
determining at least one center of gravity as a function of the seating profile; and
determining the seating position as a function of the at least one center of gravity.

2. The method according to claim 1, further comprising:
dividing the seating profile into regions;
determining respective centers of gravity for the regions; and
determining the seating position as a function of the respective centers of gravity.

3. The method according to claim 1, further comprising:
comparing the at least one center of gravity with stored data; and
determining the seating position as a function of the comparison.

4. The method according to claim 1, further comprising using the seating position in conjunction with at least one additional feature for occupant classification.

5. The method according to claim 4, wherein the at least one additional feature includes at least one of (a) a distance between ischial tuberosities, (b) a seating profile size, and (c) a weight estimate.

6. The method according to claim 1, further comprising using the seating position for evaluation of the seating profile.

7. The method according to claim 1, further comprising using the seating position for a rollover detection system.

8. The method according to claim 1, further comprising using the seating position for checking sensor values.

9. A device for determining a seating position of an object on a vehicle seat, comprising:
a seat mat with a sensor matrix for determining a seating profile of the object; and
a processor for determining at least one center of gravity as a function of the seating profile and for determining the seating position as a function of the at least one center of gravity.

10. The device according to claim 9, wherein the processor determines respective centers of gravity for regions of the seating profile and determines the seating position as a function of the respective centers of gravity.

11. The device according to claim 9, further comprising a control device for a restraint system connected to the processor.

12. The device according to claim 9, further comprising a vehicle bus connected to the processor.
